(19) United States
(12) Patent Application Publication
(10) Pub. No.: US 2013/0017387 A1
(43) Pub. Date: Jan. 17, 2013

(54) CHEMICALLY DURABLE POROUS GLASS WITH ENHANCED ALKALINE RESISTANCE

(71) Applicants: William H. JAMES, III, Clarks Summit, PA (US); Sally Pucilowski, Duryea, PA (US); Eric H. Urruti, Duryea, PA (US); Matthias Bockmeyer, Mainz (DE)

(72) Inventors: William H. JAMES, III, Clarks Summit, PA (US); Sally Pucilowski, Duryea, PA (US); Eric H. Urruti, Duryea, PA (US); Matthias Bockmeyer, Mainz (DE)

(21) Appl. No.: 13/181,302

(22) Filed: Jul. 12, 2011

(51) Int. Cl. B32B 17/06; C03C 3/095; C03C 3/089; B05D 7/00; C03C 3/093; C03B 19/10; B32B 5/18; B32B 5/16; C03C 3/04; C03C 3/091

(52) U.S. Cl. 428/307.7; 501/53; 501/64; 501/65; 501/66; 501/67; 65/17.2; 427/215

(57) ABSTRACT

Disclosed are a phase separable glass compositions used to produce chemically durable porous glass, e.g., porous glass powder, and the application of a sol gel coating to the glass to enhance chemical durability of the glass in alkaline solutions, and to the use of the glass, e.g., glass powder, as substrates for separation technology where harsh alkaline environments (pH≧12 e.g., pH 12-14) are routinely prevalent.

The invention relates to alkaline resistant porous glasses and methods for the preparation and use thereof. More specifically, the invention relates to phase separable glass compositions used to produce chemically durable porous glass, e.g., porous glass powder, and the application of a sol gel coating to the glass to enhance its chemical durability in alkaline solutions.

The glasses of the present invention are particularly applicable as substrates for separation technology where harsh alkaline environments (pH≧12 e.g., pH 12-14) are routinely prevalent. One embodiment concerns the separation of biological molecules, where a coated porous powder of the present invention can be applied or used without modification as a size exclusion substrate, or the surface can be functionalized with a variety of ligands to act as an affinity based separation substrate. For example, the alkaline resistant glasses of the present invention are useful in FDA required regeneration protocols, which include aggressive caustic leaching (pH>12) to remove residual bioburden.

Applications where alkaline resistant porous glass plays a significant role include, but are not limited to, separation of biological molecules, separation/sequestering of gases, and filtration of liquids. Furthermore, chemically durable porous glass, particularly alkaline resistant porous glass, has commercial value as a bio-separation substrate for the separation, purification, and manufacturing of monoclonal antibodies. In this field, FDA mandated cleaning-in-place protocols for the removal of bioburden during chromatography column regeneration have caused an industry wide bottleneck with respect to implementing porous glass as a solution. The present invention addresses this problem, providing an alkaline resistant porous glass with significantly improved properties.

U.S. Pat. No. 3,549,524 and U.S. Pat. No. 3,758,284 disclose a material and method for producing controlled pore glass for use in steric separations.

U.S. Pat. No. 4,665,039 discloses porous glass compositions and a process for producing porous glass. U.S. Pat. No. 4,665,039 aim was to minimize breakage and cracking during production, produce porous glass over a range of pore sizes (5-4000 nanometers), and improve alkaline resistance and high flexural strength.

U.S. Pat. No. 4,778,777 discloses chemically durable porous glass, and teaches incorporation of ZrO₂, ZnO, and Al₂O₃ to improve the chemically durability of the porous glass.

U.S. Pat. No. 4,657,875 discloses porous glass with increased Al₂O₃ content to improve chemical durability.

U.S. Pat. No. 3,783,101 and U.S. Pat. No. 4,025,667 disclose porous glass with a ZrO₂ coating derived from either ZrOCl₂ or a zirconium chelate. The coating was applied to controlled pore glass powder for the immobilization of enzymes.

U.S. Pat. No. 4,661,138 discloses a method of strengthening the alkaline resistance of SiO₂-B₂O₃—Na₂O porous glass via application of a thin film of ZrO₂.

U.S. Pat. No. 4,780,369 and U.S. Pat. No. 4,042,359 discloses a porous glass membrane tube and process for production of porous glass membrane tubes from phase separated alkali borosilicate for application in extraction/filtration processes.

Other relevant publications teaching various application of alkaline porous glasses include, Haller, “Application of Controlled Pore Glass in Solid Phase Biochemistry,” Chapter 11, p. 535-597 in ‘Solid Phase Biochemistry’ 1983 and Schnabel et al., “Separation of protein mixtures by bioran porous glass membranes” Journal of Membrane Science v. 36, p. 55-66, 1988.

In one aspect, the present invention relates to an improved alkaline resistant phase separable sodium borosilicate glass. Typical sodium borosilicate glasses, which are also the subject of the present invention, contain in the starting glass composition, on an oxide basis by weight, e.g., 40-80% SiO₂, 5-35% B₂O₃ and 1-10% Na₂O, preferably 45-65% SiO₂, 20-30% B₂O₃ and 2-8% Na₂O, and more preferably 50-55% SiO₂, 25-27% B₂O₃ and 5-7% Na₂O. Other ingredients include, for example, ZrO₂, TiO₂, Al₂O₃, CaO and/or ZnO, and optionally further ingredients are permissible, e.g., Mg, Fe, Mn, Ce, Sn, etc., and other impurities, preferably in amounts that do not adversely affect the alkaline resistance of the glasses nor the ability of the glass to phase separate.

The current invention in a preferred embodiment relates to a process of making glasses by applying a ZrO₂ or TiO₂ based sol gel coating to a porous, alkaline resistant, sodium borosilicate glass containing additives, e.g., ZrO₂, TiO₂, Al₂O₃, CaO and/or ZnO, which enhance the alkaline resistance of the glass, and to glasses obtained by such a process.

Applicants have found that when both additives are added to a porous borosilicate glass composition and a coating is applied onto the glass, each to enhance the alkaline resistance of the porous borosilicate glass, a synergistic effect occurs whereby the improvement in alkaline resistance is unexpectedly and significantly enhanced. Such an improved glass provides significant advantages in an art where, for example, when used as a substrate in separation technology under pH 12-14 conditions, the life of the glass is significantly elongated. Such results in significant cost reductions and less interruptions in processing, e.g., the substrate is not required to be changed and/or replenished as often.

In one embodiment, additives to improve the alkaline resistance of glass compositions, such as ZrO₂, TiO₂, Al₂O₃, CaO and/or ZnO are incorporated in a sodium borosilicate glass batch. The batch is melted and processed into a porous glass powder. Thereafter, a ZrO₂ and/or TiO₂ and/or CeO₂ and/or La₂Zr₂O₇ and/or Ce₂Zr₂O₇ and/or La₂Ti₂O₇ and/or Gd₂Ti₂O₇ and/or Ce₂ZrTiO₇ and/or Gd₂ZrTiO₇, preferably a ZrO₂, based sol gel coating is applied to the porous glass powder to enhance the alkaline resistance of the material. In some embodiments, the coating is applied in multiple steps, for example, two or three steps, preferably, two steps. In some embodiments the sol is stabilized and in other embodiments it is not stabilized.

In some special embodiments one or more oxides of Gd, Ca, Na, Y, Mg, La, Ce, Zn, Sm, Hf, Si, Al, may be added in 0.1-50 mol-%, preferably in 1-20 mol-% as dopant to the sol-gel-coating. This dopant stabilizes the preferred crystal phase and/or increases the alkaline chemical resistance of the coating.

In a preferred embodiment, the glass is in a powder form. A monolithic piece of glass is also within the scope of the invention having the herein described characteristics. Noted is however that the ability to form physically acceptable monolithic pieces depends greatly on the composition as many sodium borosilicate glasses deteriorate (i.e., crumble) during the leaching process to powder.

Representative glass compositions having improved alkaline resistance are shown in Table I. Additives, such as ZrO₂, TiO₂, Al₂O₃, CaO and/or ZnO contribute to increased chemical durability in alkaline solutions. The glass is prepared by mixing the materials listed to achieve a given composition to produce a batch. The batch is placed in a crucible, for example, in a platinum crucible, and heated to a temperature in excess of 1400° C. to melt the raw materials.

The glass is annealed and heat treated to induce phase separation. The phase separation creates a boron-rich soluble phase and a silica-rich insoluble phase. The phase separated glass is pulverized into a powder of desired particle size. The glass powder is leached in acid, for example, 8%-12% hydrochloric acid at 60° C.-100° C. to create a porous glass. After the pore forming acid leach, the open pores contain colloidal silica, a decomposition product formed during the acid leach. In order to remove the colloidal silica, the porous glass product is cleaned in a basic solution, e.g., sodium hydroxide bath. The duration of the pore cleaning wash and concentration of the caustic solution used are determined by the glass composition and particle size, so as not to leach away the silica-rich phase. The porous glass powder is optionally dried, for example, overnight at 75° C.-100° C.

As known and discussed above, sodium hydroxide has the ability to leach away the silica rich phase also as a function of duration and concentration.

To test the alkaline resistance of the product, it is exposed to a concentrated sodium hydroxide bath for a predetermined time. At the end of the test, the remaining weight of the porous glass powder, i.e., the material that did not leach away, can be measured as an indication of how resistant the glass product is to alkalinity. The result can be reported as either the amount remaining or the amount that leached away, i.e., as weight loss.

Similar types of tests are known in the art, for example, for testing the alkaline stability of ligands. See, e.g., US 2010/0221844 teaching to expose ligands to 0.5M NaOH for 5, 10, 15, 20, 25 or 30 hours to test their alkaline resistance. See also the publications from GE Healthcare titled “Lifetime performance study of MabSelect SuRe™ LX during repeated cleaning-in-place,” and “MabSelect SuRe Alkali-stabilized protein A-derived medium for capture of monoclonal antibodies,” both teaching the testing of alkali resistance of ligands with 0.1 M or 0.5 M NaOH.

The alkaline resistance is enhanced by the application of a sol gel coating. In a preferred embodiment, the alkaline resistant porous glass powder is immersed in a zirconia sol, e.g., an optionally cerium oxide stabilized zirconia sol, or a titania sol, which can also be optionally stabilized, and agitated for a sufficient time to ensure that the entire surface area has been coated, i.e., 1 to 2 hours typically. The porous glass powder is dried overnight at 90-110° C. The dried powder is fired at temperatures ranging from 500-800° C. to produce a dense, non-porous coating. In some embodiments the porous glass powder is immersed in cerium oxide stabilized zirconia sol, or in a titania sol, dried, and fired more than once, for example, twice. In certain embodiments, the glass is fired longer in the first immerse, dry, and fire cycle than in the subsequent cycles.

In one preferred embodiment, the content of CeO₂ in the ZrO₂ coating is between 0-50 mol %, preferably 1-25 mol %, more preferably 5-10 mol %.

The sol-gel-coatings, for example, the ZrO₂ and/or TiO₂ and/or CeO₂ coating contains a nanocrystalline ceramic material. The sol-gel-coating in general contains a granular nanocrystalline microstructure, The porosity of the coating is, in a preferred embodiment, between 1-25 volume %, more preferably between 2-15 volume %. The porosity is due to mesopores with a pore diameter of 2-10 nm, preferably 2-5 nm, and/or micropores with a pore diameter below 2 mm In a special embodiment the pores are all or partly closed pores, which are not measurable by sorption methods, such as N₂-sorption. ZrO₂ preferably shows pores with diameter below 5 nm, more preferably below 3 nm.

The film thickness of the sol-gel-coatings is, in an embodiment, between 4-500 nm, preferably between 10-250 nm, more preferably between 15-150 nm. The surface roughness of the coatings is, in a special embodiment, preferably below 20 nm, more preferably below 5 nm. The surface roughness can be measured by atomic force microscope,

The crystallite size for the ZrO₂ coating is between 4-50 nm, preferably between 7-40 nm, more preferably between 10-30 nm. The crystal phase of the ZrO₂ is, in one preferred embodiment, tetragonal and/or cubic and/or monoclinic. Whereas in one special embodiment the tetragonal phase ZrO₂ is the more preferred phase.

The crystallite size for the TiO₂ coating is between 8-250 nm, preferably between 10-150 nm, more preferably between 14-100 nm. The crystal phase of the TiO₂ is, in one preferred embodiment anatase and/or rutile. In another preferred embodiment CeO₂ doped TiO₂ is used as coating. The content of CeO₂ in the TiO₂ coating is between 0-50 mol %, preferably 1-25 mol %, more preferably 5-10 mol %.

It is important that the boron-rich phase of the glass is substantially removed, so that a suitable porous glass would form.

In one embodiment, the percent of ZrO₂ in the glass composition by weight is 1 to 12%, preferably 4 to 10%, more preferably 5 to 9%.

In another embodiment, the percent of TiO₂ in the glass composition by weight is 1 to 10%, preferably 1 to 7%, more preferably 2 to 5%.

In a further embodiment, the percent of Al₂O₃ in the glass composition by weight is I to 10%, preferably 2 to 5%, more preferably 3 to 4%.

In yet another embodiment, the percent of CaO in the glass composition by weight is 1 to 10%, preferably 3 to 8%, more preferably 4 to 6%.

In a further embodiment, the percent of ZnO in the glass composition by weight is 1 to 10%, preferably 3 to 8%, more preferably 4 to 6%.

In another further embodiment, the concentration of the sol is 0.2% to 7% ZrO₂, preferably 0.5% to 6% ZrO₂, more preferably 0.5% to 1% ZrO₂.

In another embodiment, the concentration of the sol is 0.2% to 7% TiO₂, preferably 0.5% to 6% TiO₂, more preferably 0.5% to 1% TiO₂.

In some embodiments, two coats of sol gel, e.g., ZrO₂ based sol gel, coatings are applied.

In a further embodiment, the sol-gel-coating, especially the ZrO₂ or TiO₂ based sol gel coating after having been applied to the glass is fired at temperatures ranging from 600-800° C., preferably 650-750° C.

In another embodiment, the glass particles are pulverized to a size between 0.1-500 microns, preferably 75-300 microns, more preferably 100-200 microns, and even more preferably 125-175 microns.

In some embodiments, hydrochloric acid is used to substantially remove the boron-rich phase.

In a preferred embodiment, preparing a porous, alkaline resistant, sodium borosilicate glass includes:
A. melting ingredients for a sodium borosilicate glass to a molten state,
B. coating and annealing in a manner that minimizes or prevents phase separation,
C. phase separating the class into a boron-rich soluble phase and a silica-rich insoluble phase,
D. pulverizing the glass into particles of 100-200 microns, preferably 125-175 microns, in size,
E. creating pores in the glass particles by leaching the boron-rich phase from the glass in hydrochloric acid with minimal or no leaching of the silica-rich phase,
F. cleaning the glass partials in a sodium hydroxide bath with minimal or no leaching of the silica-rich phase,
G. immersing glass particles in an optionally cerium oxide stabilized zirconia sol or optionally stabilized titania sol, or others as discussed above,
H. agitating the glass particles in the sol,
I. removing the glass particles from the sol,
J. drying the glass particles, and
K. firing the glass particles at a temperature of 600 to700° C.

### EXAMPLES

All amounts in the examples and throughout the application are based on weight.

TABLE I

| | 1 | 2 | 3 | 4 | 5 | 6 | 7 | 8 |
|---|---|---|---|---|---|---|---|---|
| SiO2 | 54.16 | 52.40 | 52.77 | 50.93 | 53.28 | 50.61 | 52.70 | 52.12 |
| B2O3 | 26.12 | 25.99 | 25.87 | 25.73 | 26.43 | 26.23 | 26.17 | 25.86 |
| Al2O3 | 3.44 | 3.42 | 3.41 | 3.39 | — | — | — | — |
| Na2O | 5.95 | 5.92 | 5.89 | 5.86 | 6.02 | 5.97 | 5.95 | 5.89 |
| CaO | 5.17 | 5.14 | 5.12 | 5.09 | — | — | — | — |
| ZnO | — | — | — | — | 5.23 | 5.20 | 5.18 | 5.12 |
| ZrO2 | 5.16 | 5.14 | 6.94 | 7.00 | 7.03 | 6.98 | 8.02 | 8.99 |
| TiO2 | — | 2.00 | — | 2.00 | 2.00 | 5.00 | 2.00 | 2.01 |
| Mean Pore | | 43 | | | | | | |
| Diameter (nm) | | | | | | | | |
| Alkaline | | 23 | | | | | | |
| Resistance | | | | | | | | |
| Weight | | | | | | | | |
| Loss (%) | | | | | | | | |

### Example 1

Batch of composition 2 from Table 1 was melted in excess of 1500° C. until the raw materials were molten. The molten material was stirred to produce a homogenous melt, and poured into a cold mold to prevent phase separation. The glass was annealed prior to a phase separation heat treatment at 700° C. for a soak duration of 24 hours. The phase separated glass was pulverized to particles of size 125-175 microns. The glass powder was leached in 10% hydrochloric acid at 80° C. to create a porous glass. The porous glass powder was exposed to a pore cleaning caustic leach to remove any colloidal silica left in the pores after the acid leach. The porous glass powder was dried overnight at 90° C.

In order to confirm that the processed material was porous, the porous glass powder was analyzed using mercury intrusion porosimetry. This analysis confirmed that the material was porous and a mean pore diameter of 43 nm was measured. For porous glass powder 2, the weight loss resulting from the alkaline resistance test discussed above was 23%.

### Example 2

Porous glass powder of composition 2 was prepared in the same manner as in Example I The porous glass powder produced was immersed in a 0.5% cerium oxide stabilized zirconia sol for one hour. After the immersion time was complete, the powder was separated from the excess sol and dried in air overnight at 90° C. The dried porous glass powder was placed in a 700° C. furnace, and fired for ninety minutes. The porous glass powder was removed from the furnace and allowed to cool to room temperature. The coated porous glass powder was again immersed in the cerium oxide stabilized zirconia sol for 1.5 hours and agitated. The excess sol was removed and the powder was dried. The dried powder was fired at 700° C. for sixty minutes. The coated powder was then subjected to the identical alkaline resistance test as used in example 1, where the resultant alkaline resistance weight loss was 5.3%.

### Comparative Example 1

A phase separable sodium borosilicate glass of a composition known in the art to have poor durability in alkaline solutions was prepared. From the raw glass a porous glass powder was produced in accordance with the process described in Example 1. Mercury intrusion porosimetry was used to confirm that the material was porous. The mean pore diameter was measured at 253 TIM, and the same alkaline resistance test as used in example 1 led to a weight loss was 78%.

### Comparative Example 2

A phase separable sodium borosilicate glass of a composition known in the art to have poor durability in alkaline solutions was prepared. A porous glass powder was produced from the raw glass in accordance with the process described in Example 1. The porous glass powder produced was immersed in a 0.5% cerium oxide stabilized zirconia sol for one hour. After the immersion time was complete, the powder was separated from the excess sol and dried in air overnight at 90° C. The dried porous glass powder was placed in a 700° C. furnace, and fired for ninety minutes. The porous glass powder was removed from the furnace and allowed to cool to room temperature. The coated porous glass powder was again immersed in the cerium oxide stabilized zirconia sol for one hour and agitated. The excess sol was removed and the powder was dried. The dried powder was fired at 700° C. for sixty minutes. The coated powder was then subjected to the same alkaline resistance test as used in example 1, where the resultant alkaline resistance weight loss was 34,7%.

### Comparative Example 3

A phase separable sodium borosilicate glass, known in the art to have poor durability in alkaline solutions, was prepared. From the raw glass a porous glass powder was produced in accordance with the process described in Example 1. The porous glass powder produced was immersed in a 6.0% cerium oxide stabilized zirconia sol for one hour to attempt to increase the alkaline resistance nearer to that of Example 2. After the immersion time was complete, the powder was separated from the excess sol and dried in air overnight at 90° C. The dried porous glass powder was placed in a 700° C. furnace, and fired for sixty minutes. The porous glass powder was removed from the furnace and allowed to cool to room temperature. The coated porous glass powder was again immersed in the cerium oxide stabilized zirconia sol for one hour and agitated. The excess sol was removed and the powder was dried. The dried powder was fired at 700° C. for sixty minutes. The coated powder was then subjected to the same alkaline resistance test as used in example 1, where the resultant alkaline resistance weight loss was improved to 8.29%.

Comparative Example 3 (8.29% loss) achieved a substantially improved alkaline resistance relative to that of the uncoated sodium borosilicate of Comparative Example 1 (78% loss); however, the sol concentration employed herein is twelve times greater than that used in Comparative Example 2 (34.7% loss) and Example 2 (5.3% loss). Thus, the preferred embodiment of the combination solution of alkaline resistant glass with alkaline resistant sol gel based coating shows substantial improvement in alkaline resistance (Example 2, 5.3% loss).

The examples demonstrate that when both additives are added to the composition to enhance the alkaline resistance of the glass and a coating is applied for the same purpose, the alkaline resistance of the glass is unexpectedly and significantly improves to levels hitherto not known by those of skill in the art.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A porous, alkaline resistant, sodium borosilicate glass comprising on an oxide basis
A. SiO₂, B₂O₃ and Na₂O forming a glass composition,
B. ZrO₂, TiO₂, Al₂O₃, CaO and/or ZnO as an additive to the glass composition, and
C. a ZrO₂ and/or TiO₂ and/or CeO₂ and/or La₂Zr₂O₇ and/or Ce₂Zr₂O₇ and/or La₂Ti₂O₇ and/or Gd₂Ti₂O₇ and/or Ce₂ZrTiO₇ and/or Gd₂ZrTiO₇ based sol gel coating on the glass, which glass has undergone phase separation to form a boron-rich soluble phase and a silica-rich insoluble phase, and the boron-rich soluble phase has been substantially removed prior to the application of the sol gel coating.

2. A glass according to claim 1, wherein the starting composition by weight comprises
40-80% SiO₂, 5-35% B₂O₃ and 1-10% Na₂O, and
0 to 12% of ZrO₂, 0 to 10% of TiO₂, 0 to 10% Al₂O₃, 0 to 10% CaO, and/or 0 to 10% ZnO as an additive in the glass,
wherein the glass contains at least one of said additives.

3. A glass according to claim 1, which is in the form of a powder.

4. A glass according to claim 1, which has a ZrO₂ based sol gel coating.

5. A glass according to claim 1, which has a TiO₂ based sol gel coating.

6. A process of preparing a glass according to claim 1, comprising:
applying a ZrO₂ and/or TiO₂ and/or CeO₂ and/or La₂Zr₂O₇ and/or Ce₂Zr₂O₇ and/or
La₂Ti₂O₇ and/or Gd₂Ti₂O₇ and/or Ce₂ZrTiO₇ and/or Gd2ZrTiO₇ based sol gel coating to a porous, alkaline resistant, sodium borosilicate glass containing
A. SiO₂, B₂O₃ and Na₂O forming a glass composition, and
B. ZrO₂, TiO₂, Al₂O₃, CaO and/or ZnO as an additive to the glass composition.

7. A process according to claim 6, which comprises applying a ZrO₂ based sol gel coating.

8. A process according to claim 6, which comprises applying a TiO₂ based sol gel coating.

9. A process of claim 6, wherein the starting composition of the glass by weight comprises
40-80% SiO₂, 5-35% B₂O₃ and 1-10% Na₂O, and
0 to 12% of ZrO₂, 0 to 10% of TiO₂, 0 to 10% Al₂O₃, 0 to 10% CaO, and/or 0 to 10% ZnO as an additive in the glass,
wherein the glass contains at least one of said additives.

10. A process of claim 6, wherein two coatings of the ZrO₂ based sol gel coating are applied.

11. A process of claim 6, wherein the glass particles are pulverized to a size between 0.1-500 microns prior to coating.

12. A process of claim 6, wherein the ZrO₂ based sol gel coating is applied by immersion of the glass into a 0.5 to 6.0% cerium oxide stabilized zirconia sol.

13. A process of claim 6, wherein the ZrO₂ based sol gel coating is applied by immersion of the glass into a 0.5% cerium oxide stabilized zirconia sol.

14. A process according to claim 6, comprising
A. melting SiO₂, B₂O₃ and Na₂O, and ZrO₂, TiO₂, Al₂O₃, CaO and/or ZnO to a molten state,
B. cooling and annealing in a manner that minimizes or prevents phase separation,
C. phase separating the class into a boron-rich soluble phase and a silica-rich insoluble phase,
D. pulverizing the glass into particles of 100-200 microns in size,
E. creating pores in the glass particles by leaching the boron-rich phase from the glass in hydrochloric acid with minimal or no leaching of the silica-rich phase,
F. cleaning the glass partials in a sodium hydroxide bath with minimal or no leaching of the silica-rich phase,
G. immersing glass particles in an optionally cerium oxide stabilized zirconia sol or an optionally stabilized titania sol,
H. agitating the glass particles in the sol,
I. removing the glass particles from the sol,
J. drying the glass particles, and
K. firing the glass particles a temperature of 600 to 700° C.
